(19) United States
(12) Patent Application Publication
(10) Pub. No.: US 2011/0025485 A1
(43) Pub. Date: Feb. 3, 2011

(54) Heat Dissipation System for Headlight

(75) Inventors: Hae Ryong Kim, Incheon (KR); Young Min Kim, Seoul (KR); Byung Kyu Yoon, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/779,691

(22) Filed: May 13, 2010

(30) Foreign Application Priority Data
Jul. 28, 2009 (KR) 10-2009-0068956

(51) Int. Cl. B60Q 1/00; B60Q 1/02

(52) U.S. Cl. 340/438; 315/82

(57) ABSTRACT

A heat dissipation system for a headlight and a headlight cooling method thereof, may include the headlight, a fan motor rotating a cooling fan to circulate air around the headlight while the headlight is operating, a driver integrated circuit monitoring an operation of the fan motor while the headlight is operating, wherein the driver integrated circuit generates a breakdown signal if the fan motor stops while the headlight is operating, a warning light device mounted on an instrument cluster of a vehicle, wherein the warning light device notifies a driver of whether the fan motor is broken down or not, and an electronic control unit operating the warning light device by receiving the breakdown signal from the driver integrated circuit.

### CROSS REFERENCE TO RELATED APPLICATION

The present application claims priority to Korean Patent Application Number 10-2009-0068956 filed on Jul. 28, 2009, the entire contents of which application is incorporated herein for all purposes by this reference.

### BACKGROUND OF THE INVENTION

1. Field of the Invention

The present invention relates to a heat dissipation system for a headlight that dissipates heat from the headlight by circulating air around the headlight using a cooling fan, and more particularly, to a heat dissipation system for a headlight that is designed to notify a driver whether or not a fan motor for a cooling fan is operating.

2. Description of Related Art

In general, lights of a vehicle are used for the purpose of illumination, which helps the driver see objects, as well as for the purpose of indication, signaling, and warning, that is, to notify other vehicles or other persons such as pedestrians on the road of the way in which the vehicle is to be driven. In particular, headlights are provided at both extremities of the vehicle in the width direction in order to illuminate the road ahead by receiving electric current through electric lines connected to a battery of the vehicle in order to improve the driver's vision while driving at night.

The headlights or rear combination lamps typically use bulbs as a light source. However, such bulbs have a short lifespan and are weakly resistant to impact. Accordingly, the use of light-emitting diodes (LEDs) as the light source has increased recently due to their merits such as long lifespan, excellent impact resistance, and high luminance.

However, such high-luminance LEDs applied to a headlight still have some problems. When turned on, the LEDs generate very high heat, and thus components around the LEDs are thermally deformed, thereby decreasing the longevity of the headlight.

Accordingly, demand for a heat dissipation system that can dissipate high-temperature heat from the LEDs to the outside is increasing.

Methods for dissipating high-temperature heat from the LEDs to the outside include a method of mounting heat dissipation fins such that heat from the LEDs can be transmitted to the fins and a method of circulating air around the LEDs using a cooling fan. The method of mounting heat dissipation fins requires the heat dissipation fins to be directly or indirectly in contact with the LEDs. This complicates the structure of the LED lamp, thereby making it difficult to fabricate the headlight. Furthermore, the heat dissipation performance is not sufficient. Accordingly, a lot of research and development has been undertaken recently to develop the method that uses the cooling fan.

Such an LED applied to the headlight typically has a lifespan of 10,000 hours or more, whereas it is difficult for the fan motor that rotates the cooling fan to maintain a lifespan of 10,000 hours or more. In some cases, the cooling fan may not operate while the LED is normally generating light. If only the LED generates light while the cooling fan is not operating, the lifespan of the LED can be significantly reduced since it is heated to a very high temperature; moreover, surrounding devices can also be damaged by the heat of the LED.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a heat dissipation system for a headlight that is designed to notify a driver whether or not a fan motor for a cooling fan is operating normally, thereby preventing the headlight from overheating.

In an aspect of the present invention, a heat dissipation system for a headlight, may include the headlight, a fan motor rotating a cooling fan to circulate air around the headlight while the headlight is operating, a driver integrated circuit monitoring an operation of the fan motor while the headlight is operating, wherein the driver integrated circuit generates a breakdown signal if the fan motor stops while the headlight is operating, a warning light device mounted on an instrument cluster of a vehicle, wherein the warning light device notifies a driver of whether the fan motor is broken down or not, and an electronic control unit operating the warning light device by receiving the breakdown signal from the driver integrated circuit.

The driver integrated circuit may be designed to output a low signal when the fan motor is operating and to output a high signal when the fan motor stops, and the heat dissipation system further may include a transistor that outputs signals to the electronic control unit by receiving the high or low signal output from the driver integrated circuit, wherein the transistor outputs a high signal to the electronic control unit upon receiving the low signal from the driver integrated circuit and outputs a low signal to the electronic control unit upon receiving the high signal from the driver integrated circuit.

The headlight may be repeatedly turned on or off or dimmed when the breakdown signal is generated from the driver integrated circuit, wherein the headlight is turned off in a preset time period after the headlight starts to repeatedly turn or off or dim.

In another aspect of the present invention, the heat dissipation system may further include an overheat protection circuit, wherein, the overheat protection circuit monitors whether the breakdown signal is generated from the driver integrated circuit, and in case that the breakdown signal is detected, the overheat protection circuit controls a value of a current applied to the headlight so that a quantity of light of the headlight is reduced or the headlight is turned off.

The heat dissipation system may further include an overheat protection circuit, wherein, the overheat protection circuit monitors whether the breakdown signal is generated from the driver integrated circuit, and in case that the breakdown signal is detected, the overheat protection circuit controls a value of a current applied to the headlight so that a quantity of light of the headlight is reduced and the headlight is turned off after a preset time period.

The headlight may include a light-emitting diode lamp.

In further another aspect of the present invention, a headlight cooling method of a heat dissipation system in a vehicle, may include monitoring an operation of a fan motor, wherein the fan motor rotates a cooling fan to circulate air around the headlight when a headlight is operating, generating a breakdown signal if the fan motor stops while the headlight is operating, and notifying a driver of whether the fan motor is broken down or not.

The method may further include repeatedly turning on or off or dimming the headlight when the breakdown signal is generated.

The method may further include turning off the headlight in a preset time period after the headlight starts to repeatedly turn or off or dim.

According to various aspects of the present invention as set forth above, when the fan motor for the cooling fan is broken, it can be quickly replaced since the driver is promptly notified of the breakdown of the fan motor. Accordingly, the heat dissipation system for a headlight can advantageously prevent the lifespan of the headlight from being reduced due to overheating.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram showing an exemplary heat dissipation system for a headlight according to the present invention; and

FIG. 2 is a circuit diagram showing the exemplary heat dissipation system for a headlight according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

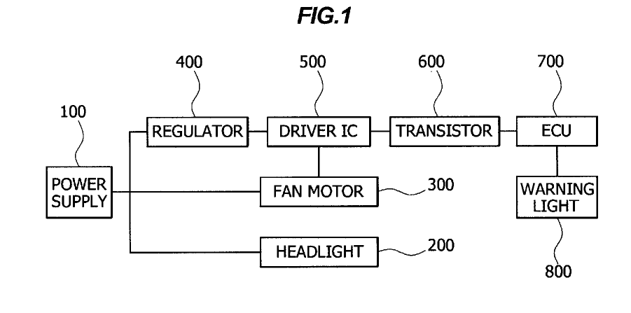

FIG. 1 is a block diagram showing a heat dissipation system for a headlight according to an exemplary embodiment of the invention.

As shown in FIG. 1, the heat dissipation system for a headlight includes a headlight 200, a fan motor 300, a driver Integrated Circuit (IC) 500, a warning light 800, and an Electronic Control Unit (ECU) 700. The headlight 200 radiates light to the road ahead of a vehicle. The fan motor 300 rotates a cooling fan to circulate air around the headlight 200 when the headlight 200 is operating. The driver IC 500 detects the operation of the fan motor 300 when the headlight 200 is operating and generates a breakdown signal if the fan motor 300 stops. The warning light 800 is mounted on an instrument cluster of the vehicle to notify a driver whether or not the fan motor 300 is broken down. The ECU 700 controls the warning light 800 in response to the breakdown signal from the driver IC 500.

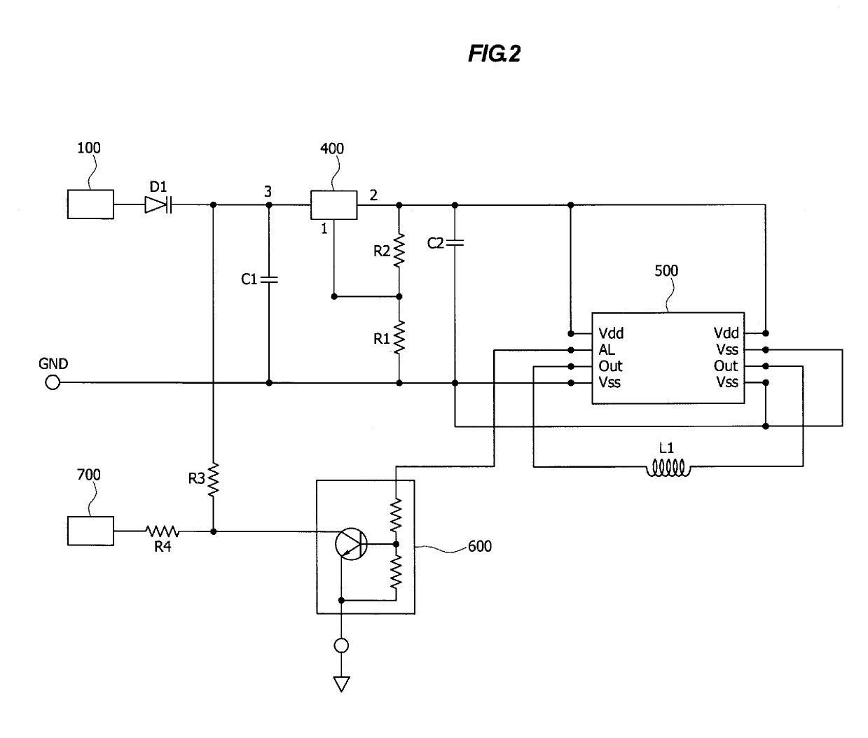

Here, a power supply 100 supplies electric power to the headlight 200, the fan motor 300, and the driver IC 500. A regulator 400 can also be provided to step down the electric power, supplied from the power supply 100, to a voltage suitable for the driver IC 500. In addition, a transistor 600, which transmits a signal from the driver IC 500 to the ECU 700 by switching the signal, can also be provided between the driver IC 500 and the ECU 700. The detailed construction and operation of the transistor 600 will be described more fully later with reference to FIG. 2.

In addition, an internal hall IC is provided inside the driver IC 500, thereby enabling detection of displacement without contact. The hall IC determines whether the fan-driving motor is operating or not by detecting a change in the polarity of a magnet of the motor. The hall IC that determines the operation of the motor is widely used in a variety of electronic devices equipped with motors, and thus a detailed description thereof will be omitted.

As such, the heat dissipation system for a headlight according to an exemplary embodiment of the invention dissipates heat from the headlight 200 by circulating the air around the headlight 200 using the cooling fan. Thus, the heat dissipation system has an excellent heat dissipation effect for the headlight 200. In addition, if the cooling fan fails to rotate due to the breakdown of the fan motor 300 or the like, a prompt warning is sent to a driver in order to prevent the headlight 200 from being continuously lighted in the state in which the cooling fan is not rotating (more particularly, in which air does not circulate around the headlight 200). This can consequently prevent the headlight 200 from being damaged by being overheated.

In addition, since the headlight 200 generates more heat when constructed with a Light Emitting Diode (LED) lamp than when constructed with a bulb lamp, the cooling fan and the fan motor 300 are essentially required for the LED lamp. Accordingly, the heat dissipation system for a headlight according to an exemplary embodiment of the invention is particularly preferable when the headlight 200 is constructed with the LED lamp.

In an abnormal state, in which only the headlight 200 is turned on while the cooling fan is not rotating, it is possible to prevent the headlight 200 from overheating by repeatedly turning on and off or dimming the headlight 200, depending on the situation. When the high-temperature headlight 200 is turned on, the LEDs can be subjected to severe thermal damage. Accordingly, an overheat protection circuit connected to the LEDs controls the value of a current flowing into the LEDs so that the LEDs are not heated to or above an LED junction temperature, thereby preventing the LEDs from being damaged. For example, the overheat protection circuit can be designed to reduce the quantity of light at an early stage when a breakdown signal is generated from the driver IC 500 and to turn off the headlight 200 later if the overheating of the headlight 200 continues, i.e., if the headlight 200 stays turned on even after a preset time period in the state, in which the quantity of light emitted therefrom is reduced. The reason for primarily controlling the current value is to reduce the likelihood of an accident. If the headlight 200 is abruptly turned off at night, the driver may not be able to see, and thus be involved in an accident. The above-mentioned overheat protection circuit is already commercialized in automatic control systems that control current value when a specific signal is generated, and the detailed construction and operating principle thereof will be omitted.

As such, the heat dissipation system for a headlight according to an exemplary embodiment of the invention can advantageously prevent the headlight 200 and a variety of devices surrounding the headlight 200 from being damaged by the heat from the overheated headlight 200. In addition, in the heat dissipation system for a headlight according to an exemplary embodiment of the invention, the warning light 800 is also turned on to notify the driver of the abnormality when the fan motor 300 is not rotating normally due to damage or deformation of the cooling fan even if the fan motor 300 is not broken or damaged. This can consequently prevent an incident such as fire due to the overloading of the fan motor 300.

In this case, the warning light 800 can stay turned on when the fan motor 300 stops. The warning light 800 can be designed to flash or flicker so that the driver is more likely to notice it. The warning light 800 can also display, for example, a strong warning sign to the driver using a recent technology such as a Thin-Film-Transistor Liquid Crystal Display (TFT LCD). Preferably, the cooling fan and the fan motor 300 can be detachably mounted on the vehicle so that they can be easily replaced when broken or damaged.

FIG. 2 is a circuit diagram showing the heat dissipation system for a headlight according to an exemplary embodiment of the invention.

A voltage of 13.5 V applied through the power supply 100 is stepped down to about 0.7 V through a reverse voltage prevention diode D1, is output at 9.5 V according to the value of R1 (1.5 kω), and is supplied to a power supply terminal Vdd of the driver IC 500. Herein, in order to transform the voltage applied through the power supply 100, a variety of designs can be made according to the characteristics of the drive IC 500 and the characteristics of the entire circuit.

The driver IC 500 supplies a current to a coil L1 through an output terminal Out so that the fan motor 300 can operate. The driver IC 500 outputs a low signal (i.e., an output bit ‘0 ’) when the fan motor 300 is operating, and outputs a high signal (i.e., an output bit ‘1 ’) if the fan motor 300 stops.

When a low signal from the driver IC 500 is sent to the base of the transistor 600, the emitter part (i.e., an earth terminal in this embodiment) of the transistor 600 is disconnected. This consequently maintains a state where electric power from the power supply 100 is applied to the ECU 700. That is, the ECU 700 stays in the state where the high signal is applied thereto.

In contrast, when a high signal from the driver IC is sent to the base of the transistor 600, the emitter part of the transistor is connected. Then, the electric power from the power supply 100 is earthed through the emitter part, and thus the ECU 700 remains in the state where the low signal is applied thereto.

As such, it is possible to freely change the signal that is applied to the ECU 700 when the fan motor 300 stops. This, as a result, can increase the freedom of design of the ECU 700 and circuits connected to the ECU 700.

The technology of outputting an input signal by switching it using the transistor 600 as described above is well known in the circuit design field, and thus a detailed description thereof will be omitted. In addition, the circuit construction of sending a signal, generated from the driver IC 500, to the ECU 700 by switching the signal can be modified into various forms other than the circuit construction illustrated in this embodiment.

Accordingly, the ECU 700 receives a high signal when the fan motor 300 is operating normally but a low signal when the fan motor 300 stops. When the low signal is applied, the ECU 700 sends a lighting signal to the warning light 800 to turn it on. The driver can observe that the warning light 800 is turned on and promptly replace the fan motor 300 if the fan motor 300 is broken. This can consequently prevent the lifespan of the headlight 200 from being reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heat dissipation system for a headlight, comprising:
the headlight;
a fan motor rotating a cooling fan to circulate air around the headlight while the headlight is operating;
a driver integrated circuit monitoring an operation of the fan motor while the headlight is operating, wherein the driver integrated circuit generates a breakdown signal if the fan motor stops while the headlight is operating;
a warning light device mounted on an instrument cluster of a vehicle, wherein the warning light device notifies a driver of whether the fan motor is broken down or not; and
an electronic control unit operating the warning light device by receiving the breakdown signal from the driver integrated circuit.

2. The heat dissipation system according to claim 1, wherein the driver integrated circuit is designed to output a low signal when the fan motor is operating and to output a high signal when the fan motor stops, the heat dissipation system further comprising:
a transistor that outputs signals to the electronic control unit by receiving the high or low signal output from the driver integrated circuit, wherein the transistor outputs a high signal to the electronic control unit upon receiving the low signal from the driver integrated circuit and outputs a low signal to the electronic control unit upon receiving the high signal from the driver integrated circuit.

3. The heat dissipation system according to claim 1, wherein the headlight is repeatedly turned on or off or dimmed when the breakdown signal is generated from the driver integrated circuit.

4. The heat dissipation system according to claim 3, wherein the headlight is turned off in a preset time period after the headlight starts to repeatedly turn or off or dim.

5. The heat dissipation system according to claim 1, further comprising an overheat protection circuit, wherein, the overheat protection circuit monitors whether the breakdown signal is generated from the driver integrated circuit, and in case that the breakdown signal is detected, the overheat protection circuit controls a value of a current applied to the headlight so that a quantity of light of the headlight is reduced or the headlight is turned off.

6. The heat dissipation system according to claim 1, further comprising an overheat protection circuit, wherein, the overheat protection circuit monitors whether the breakdown signal is generated from the driver integrated circuit, and in case that the breakdown signal is detected, the overheat protection circuit controls a value of a current applied to the headlight so that a quantity of light of the headlight is reduced and the headlight is turned off after a preset time period.

7. The heat dissipation system according to claim 1, wherein the headlight includes a light-emitting diode lamp.

8. A headlight cooling method of a heat dissipation system in a vehicle, comprising:
monitoring an operation of a fan motor, wherein the fan motor rotates a cooling fan to circulate air around the headlight when a headlight is operating;
generating a breakdown signal if the fan motor stops while the headlight is operating; and
notifying a driver of whether the fan motor is broken down or not.

9. The method of claim 8, further comprising:
repeatedly turning on or off or dimming the headlight when the breakdown signal is generated.

10. The method of claim 9, further comprising:
turning off the headlight in a preset time period after the headlight starts to repeatedly turn or off or dim.

11. The method of claim 8, wherein the heat dissipation system comprises:
a driver integrated circuit designed to monitor the operation of the fan motor and to output a low signal when the fan motor is operating and to output a high signal when the fan motor stops; and
a transistor that outputs signals to an electronic control unit by receiving the high or low signal output from the driver integrated circuit, wherein the transistor outputs a high signal to the electronic control unit upon receiving the low signal from the driver integrated circuit and outputs a low signal to the electronic control unit upon receiving the high signal from the driver integrated circuit.

12. The method of claim 11, further comprising an overheat protection circuit, wherein the overheat protection circuit monitors whether the breakdown signal is generated from the driver integrated circuit, and in case that the breakdown signal is detected, the overheat protection circuit controls a value of a current applied to the headlight so that a quantity of light of the headlight is reduced or the headlight is turned off.

13. The method of claim 11, further comprising an overheat protection circuit, wherein the overheat protection circuit monitors whether the breakdown signal is generated from the driver integrated circuit, and in case that the breakdown signal is detected, the overheat protection circuit controls a value of a current applied to the headlight so that a quantity of light of the headlight is reduced or the headlight is turned off after a preset time period.

14. The method of claim 8, wherein the headlight includes a light-emitting diode lamp.
